(19) United States
(12) Patent Application Publication
(10) Pub. No.: US 2006/0292040 A1
(43) Pub. Date: Dec. 28, 2006

(54) Hand held test reader

(76) Inventors: James Wickstead, Cedar Knolls, NJ (US); Keith Seritella, Washington, NJ (US); Brian Forbes, Wayne, NJ (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/454,214

(22) Filed: Jun. 15, 2006

Related U.S. Application Data
(60) Provisional application No. 60/691,330, filed on Jun. 16, 2005.

(51) Int. Cl. G01N 21/00

(52) U.S. Cl. 422/82.05

(57) ABSTRACT

A portable, hand-held device and method for rapid on-site screening and drug testing first automatically identifying and then using customized and proprietary test cassettes which contain a multiplicity of lateral flow test strips which are identified, read and the value of resulting test lines on the test strips extrapolated and recorded. The results are viewable to the user, automatically recorded, electronically stored and transmitted to be remotely printed and/or stored.

This application claims priority from U.S. provisional application No. 60/691,330 filed on Jun. 16, 2005, which is incorporated by reference as if fully set forth.

### FIELD OF INVENTION

The present invention relates to testing such as lateral flow testing and more particularly to portable apparatus for imaging, analyzing and recording the tests and transferring the analysis and images to remote facilities and/or printers.

### BACKGROUND

On-site screening and testing for drugs of abuse and other substances requires small, highly automated, hand-held devices which can be used in the field or within a workplace. Such test devices are typically used in law enforcement situations, for example, where testing for drugs of abuse can be administered roadside. They are also used in workplace screening and testing, to mention just a few. Such circumstances require that such devices be rugged, easy to use, battery powered with sufficient battery life, and capable of printing test results to a remote printer preferably using wireless transmission. It is also important that a person conducting such a test be able to enter information about himself (herself) and about the individual undergoing testing. This information may include date and time, driver's license number, social security, green card or other data. Ideally, this information also provides a record of the actual test for further proof and validation. The data and test information should be electronically stored to facilitate later transfer to a PC or other computer for formal record keeping. The device must be capable of reading and recording test cassettes, thereby removing the subjectivity of the user while also providing information and documentation to substantiate the results. This substantiation should come in the form of electronic data which eliminates transposition errors and provides visual and electronic records of the specific test as well as a printed test result.

In response to the industry's needs, although manufacturers have developed drug screening systems, none have successfully addressed the above requirements for a portable, field usable device which clearly and concisely links the specific test to the individual conducting the test and the person being tested. This linking and substantiation is essential for a legal document and for use in the criminal justice system where chain of custody verification is critical.

### SUMMARY

The present invention, in one preferred embodiment, is an on-site, portable test reader capable of reading the test results from one or a multiplicity of lateral flow test strips. The invention provides apparatus and method for recording of corroborating information concerning the identity of both the individual conducting the test and the person on whom the test is being performed. The apparatus is further capable of capturing all of this information as well as an image of the actual cassette, test strips, test strip control lines and individual test results and a supporting bar code and provide a single document incorporating and combining all of the information described with the test results. The document created by the portable device may be viewed and printed, and is also retained in the device for future downloading for formal record keeping, thereby providing a complete chain of custody verification.

### BRIEF DESCRIPTION OF THE DRAWING(S)

The present invention will be understood from the following detailed description and drawings wherein like elements are designated by like numerals and, wherein:

FIG. 1A is a perspective view showing top, and left and bottom sides of a portable testing device embodying the principles of the present invention.

FIG. 1B is a perspective of the device shown in FIG. 1A showing the top and bottom and right sides and further showing a test cassette which is received by the test device.

FIG. 1C is a detailed view of a test strip visible through the opening in the cassette of FIG. 1B.

FIG. 2 is an exploded perspective view of the device of FIG. 1A showing the major components of the test device.

### DETAILED DESCRIPTION OF THE PREFERRED EMBODIMENT(S)

Although the present invention is described in terms of lateral flow drugs of abuse testing, the invention can be used with testing devices incorporating any and all bodily fluids such as oral fluid, urine and blood to name just a few. In addition, the invention may be used with other tests not including bodily fluids. These tests may include anthrax, explosive substances or other tests which provide test results capable of reading and dissemination to remote devices.

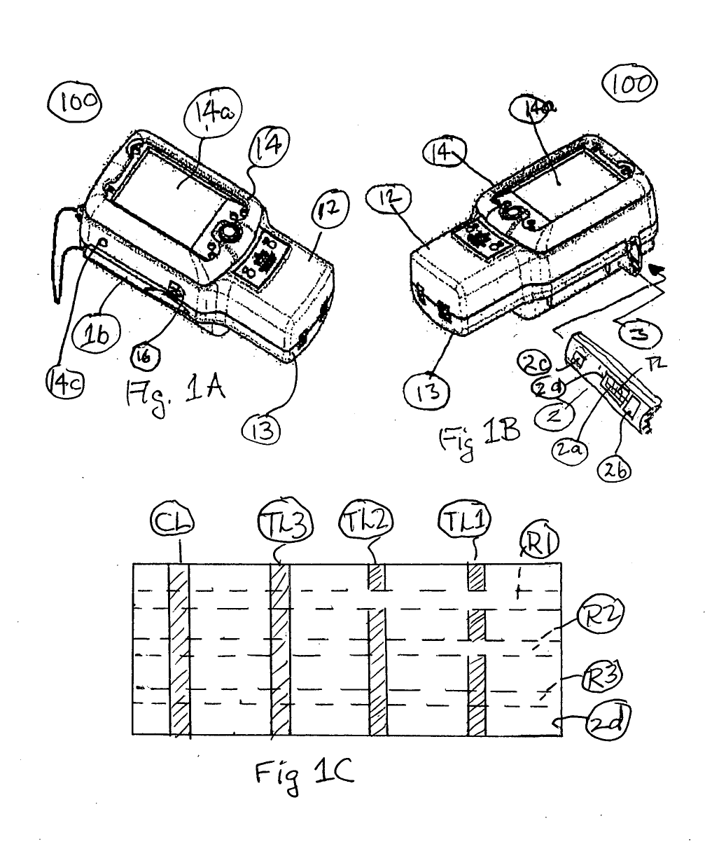

FIGS. 1A and 1B show a testing situation including the test device 100 and disposable testing cassette (2) received by the test device 100.

To use the system, a sample is first collected and the test cassette (2) is now ready for processing.

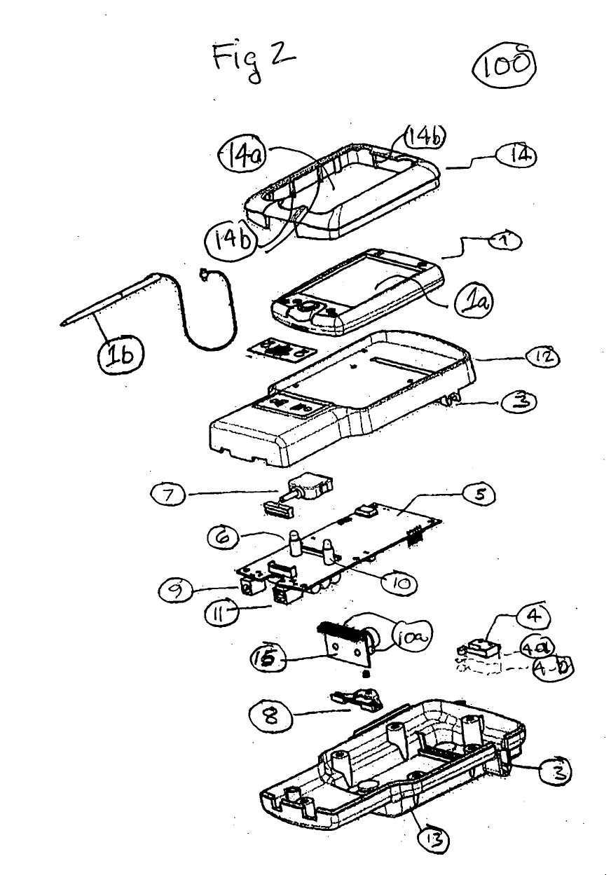

FIG. 2 shows the major inventive components of test device (100). Making reference to FIGS. 1A through 2, the device is turned on by first activating the resident personal digital assistant (PDA), which preferably a PDA/IPAQ (1), and which also incorporates custom software specific to the invention for processing the test strip data. The PDA/IPAQ (1) displays prompts, such as a series of forms to be filled out by the user on screen (1a). Each screen image guides the entry of information which may be specific to both user (tester) and to the individual (or other object or substance) being tested. When this information is complete, a test screen is initialed by depressing a “button” on the touch screen. A test cassette (2) is placed in the cassette entry port (3) which is an entrance port designed for a specific testing cassette to make it light-tight and provide proper tracking and orientation of the cassette. The orientation of the cassette allows it to be read by the imager (15) which is preferably an electronic imager such as a charge coupled device (CCD). When the cassette is inserted into place, an actuation switch (4) is depressed by the projection (2c) on cassette (2), telling the logic and processing electronics (5) that a valid cartridge has been detected. As an alternative arrangement, switch (4) may be replaced by a plurality of switches (4), (4a) and (4b), each designed to be selectively depressed by placing projection (2c) at a location selected to engage only one of the switches, providing identification of three (3) different cartridges, for example. As another alternative, combinations of three (3) projections being either omitted or present provides a capability of detecting the presence of seven (7) different cassettes, since at least one of the projections must be present to assure that the presence of a cassette is positively detected to initiate the data collection process. Alternatively, the projection(s) may be replaced by small areas (i.e., “dots” or “squares”) which are reflective or non-reflective or of contrasting colors and switch(es) (2c) is (are) replaced by light source/light sensor combinations to detect reflection or non-reflection of light or of light of a given color (by providing filters in front of each light sensor). Providing three (3) reflective dots provides the ability to detect seven (7) different cassettes. Obviously, using several different colored dots provides an even greater number of combinations. Alternatively, the dots may be captured by the image capturing digital camera (15) and software in the logic and processing electronics assembly (5) is employed to determine the type of cassette inserted into the testing device. The identification of the type of cassette is thus provided to the logic and processing electronics assembly (5) to perform the proper test.

The status information is conveyed to the user by flashing the test light (6). Pressing the run switch (i.e., push button) on the PDA/IPAQ (1) causes the logic and processing electronics assembly (5) to initiate operation of built-in imager (15) (preferably a CCD-type digital camera) which captures the image of the test cassette (2) including test strip(s) (2a) as well as bar code information provided at (2b) on the surface of the cassette adjacent to the test strip window (2d). Lights (10a), which are preferably LEDs, are provided on opposite sides of the imager (15) and “flash” when the test strip image is captured. The lights emit green light to significantly enhance the sharpness of the captured image. This information is first processed by the electronics (5) and then transmitted to the PDA/IPAQ (1) via a special interface cable (7) which connects the electronics to the PDA/IPAQ's serial input port. The raw image data is preferably transferred from imager (15) to PDA/IPAQ (1) via an RS232 serial port configured to operate at 115,000 baud, No parity, 8 data bits, 1 stop bit. The test cassette information is examined by custom software on the PDA/IPAQ and each of the tests on the test cassette is “read.”

The opening (3) in housing (12, 13) is illuminated by an internal light source (not shown) mounted on the circuit board (5) to assure easy location and insertion of a cassette under low light conditions.

The light is activated by depressing a small plunger (16) of a moment switch located on the left side of the reader housing (12). The light is turned off upon release of the switch.

A Polaroid, filter (not shown), Polaroid is a registered trademark of the Polaroid Corporation, is placed behind the lens element and the CMOS imaging device of camera (15) to reduce reflections from the surface of the plastic cassette (2) and thereby provide image enhancement.

The algorithm employed by PDA/IPAQ (1) to determine the presence and type of drug (or other substance) is to scan a given area of the captured image to detect a line in the raw image data for a dark (i.e., low reflective) image which represents a line. The dark value area is integrated over the given area and is compared with an area adjacent to the given area which is a white or light area. If the difference of these integrated values is greater than a given threshold, a line is considered to be present. Each test strip is provided with a “Control Line” (CL), which is identified as a starting point. The presence of a CL is determined in accordance with the above algorithm, the position of the control line being known within a given tolerance region on either side of a “precise region”, i.e., a region which the control line would occupy if the precisely aligned in the cassette. The CL serves as a reference point for evaluating the test lines representing the test results. One test strip (2a) is shown in greater detail in FIG. 1C (typically two test strips are provided in the cassette—only one will be described herein for purposes of simplicity, both test strips being similar in design and function). The test lines (TL1) through (TL3) and control line (CL) are parallel to one another. The lines (CL) and (TL1-TL3) are applied to the test strip when manufactured and are initially invisible. The control line (CL) is furthest from the right-hand end of the strip, which is the point of entry of the solution being tested. Tests for three different substances are made at spaced intervals along each test line represented by the dotted line regions (R1-R3). The control line however, tests only for the presence of saliva. The movement of the saliva past the control line assures that the saliva has passed all of the test lines. As the solution, saliva, for example, moves toward the left-hand end of the test strip, it passes each test line, causing the “line” it passes to appear and be visible to the viewer, if the saliva does not contain the substance the test is looking for. If the substance being sought is present, as the saliva passes the first test line, (TL1), for example, the portion of test line (TL1) which intersects with region (R1) remains invisible indicating the presence of a substance being tested for and in a given percentage. Note that the portions of the test line (TL1) intersecting with regions are visible in the example shown, indicating that the substances being tested for are not present in the required amount. A different percentage amount of the substance being tested for is determined by each of the test lines (TL1-TL3). The control line, in addition to assuring that the saliva has passed all three test lines, also serves to precisely locate the three test lines. For example, if the test strip is not precisely aligned in the cassette or is less than the precise length when manufactured, when the control line is located, by the algorithm described above, the separation distances of the test lines nevertheless remain constant, and thereby enable the electronics to precisely locate each of the test lines, to compensate for a deviation from precision alignment of the test strip in the cassette. Positive and negative values of the test lines TL are determined relative to the control line CL. If a control line is not detected, tests on the test strip being examined are considered “Invalid.” The image of the test strip is preferably compressed into a standard 4-bit monochrome .bmp file by logic and processing electronics assembly (5), enabling the pocket PC (i.e., PDA/IPAQ (1)) to display the image in a standard format.

At the completion of the test cycle (which is performed in 6-8 seconds), the results are displayed on the PDA/IPAQ (1) screen (1a) along with an image of the test cassette including test strips and associated bar code (2b). This information, as well as the filled out test forms await signature of the tester entered by stylus (1b) held by a holder provided along the left-hand side of the housing (12, 13) and are then electronically stored within the PDA/IPAQ memory. If desired, the forms and test results may also be printed and/or transmitted by wireless unit (not shown) to a remote facility. For example, the image of the test strip and test results may be transferred from PDA/IPAQ (1) to a desktop personal computer (PC—not shown) employing Microsoft“s ActiveSync software (Microsoft and ActiveSync are registered trademarks of Microsoft Corporation). Test results data can be transferred to a wireless printer via a Bluetooth wireless channel (Bluetooth is a registered trademark of Bluetooth SIG, Inc.).

Due to the alignment requirements of the imager (6), an imager adjustment plate (8) is provided to allow outside adjustment of the imager during initial assembly.

The complete product may be remotely charged using an AC adapter accessed through the charger access port (9). In this case, both the PDA/IPAQ (1) and the logic and processing electronics (5) are charged at the same time, however, the recharging of both is controlled by the logic and processing electronics (5). The state of battery charge is shown on the PDA/IPAQ display as well as by flashing the charge light (10) on the logic and processing electronics.

Test information may be downloaded from the PDA/IPAQ to a PC or other host device using a built in USB port (11).

The test results may also be sent to a printer using the USB port (11) outlet or to a wireless printer using a Bluetooth or other wireless link by pressing the print button on the PDA/IPAQ (1) screen (1a).

The complete electronic assembly and PDA/IPAQ is contained in a common housing comprised of housing halves (12,13) which provides light control, protection of components and provides for the use of various, different PDA's, IPAQ's and other similar devices by providing a PDA/IPAQ cover (14) which retains the PDA/IPAQ in position and has an opening 14a for viewing the PDA/IPAQ screen (1a).

The arrangement and look of user screens and menus on the PDA/IPAQ screen (1a) include the following:

A menu driven system is provided and includes several user selected screens to facilitate activation of specific features and provide visual and audible display and indications of the results of primary functions of the device.

An introductory screen indicating that the system is ready to use, includes:

An image capture process bar just below the center of the screen.
i. A battery charge level bar with the % of battery charge remaining to the right of the bar.
ii. Four softkeys to: a) enter data on the subject under test; b) initiate a test; and c) obtain system information.
iii. Selection of optional features such as a keypad or written entry of alphabetical or numeric characters (employing stylus (1b) as set forth above).

A test results screen with an image display area showing the visual test results as they appear on the chemical test strip of the cassette (2), including:
i. A signature entry area for administrative signatures (by stylus (1b)).
ii. Results of test analysis such as pass, fail, and the nature of the substances detected.
iii. Softkeys at the bottom of the touch-screen (1a) to select features such as request for a printout, information form, signature erasure, and print previews.
iv. Exiting the screen and returning to the previous screen to initiate the next test.

The physical design of reader housing is configured to adapt to many different pocket PC's.

The reader can accept a variety of PDA configurations simply through modifications to the PDA Retaining Bezel (14).

These modifications include changes to size/shape of the opening (14a) and the length of thin interior ribs (14b) that locate and secure PDA (1) within housing halves (12,13).

In order to enable the reset button of the PDA (1) to be operated without having to remove the pocket PDA from the reader, a small, inconspicuous access hole (14c) is provided near the upper left-hand corner of faceplate (14). A guide, such as a hollow cylinder is integrally molded into the housing 12 and extends inwardly toward the PDA (1) to guide a small diameter dowel or a straightened end of a paper clip, for example, to engage and depress the reset button (not shown), enabling the operator to reset the PDA without disassembly.

What is claimed is:

1. Portable hand-held apparatus for processing test results obtained by a test strip arranged in a test holder, comprising:
a housing having a port for receiving said holder;
an imaging device in said housing for forming an image of the test results;
a processor in said housing for converting the captured image into a format suitable for transfer at an output of said processor;
said housing having a display opening;
a digital data handling device arranged in said housing and having a display visible through said display opening;
a cable for communicating an output from said processor to said data handling device;
said data handling device comprising:
a controller for evaluating the transferred output; and
manual input means for inputting data to be associated with said image presented by said data handling device.

2. The apparatus of claim 1 wherein said digital handling device is removably inserted into said housing and having a coupling for removable connection with said cable.

3. The apparatus of claim 1 further comprising:
an adjustable mounting in said housing for adjustably positioning said imaging device to assure proper alignment with a portion of said test holder to be imaged.

4. The apparatus of claim 1 wherein said imaging device captures an image of said test holder including said test strip in said test holder, so that the test results are visible through an opening in said test holder, as well as indicia identifying the test holder and provided on an exterior of said test holder exposed to and facing said imaging device.

5. The apparatus of claim 1 wherein said imaging device comprises:
means for converting an optical image into an electrical signal; and
an optical system for focusing an image of a test holder into said converting means.

6. The apparatus of claim 1 wherein said data handling device comprises:
means for converting the electrical image into digital data; and
means for outputting results based upon said digital data and criteria stored in a memory in said processor.

7. The apparatus of claim 1 wherein said data handling device comprises a personal digital assistant (PDA).

8. The apparatus of claim 7 wherein said PDA is a PDA/IPAQ.

9. The apparatus of claim 8 wherein said PDA/IPAQ includes a display and means for converting data received from said processor for generating said captured image on said display accompanied by said results.

10. The apparatus of claim 9 wherein said PDA/IPAQ further comprises:
a stylus for manually entering hand-written data.

11. The apparatus of claim 10 wherein said hand-written data includes a signature of an operator of said apparatus for authenticating a output displayed by said PDA/IPAQ.

12. The apparatus of claim 8 wherein said PDA/IPAQ comprises:
means for communicating said output to a remote facility by one of a wired and wireless communication.

13. The apparatus of claim 12 wherein said remote facility is a printer.

14. The apparatus of claim 12, the PDA/IPAQ further comprising:
means for storing the output results for subsequent transfer to the remote facility.

15. A method for operating a test processor, comprising:
operating a start button, to initiate a program stored in the processor which:
presents prompts for entry of data entered by a user into the processor responsive the prompts;
inserting a test cassette containing results of a test on a test strip visible through a window of the test cassette into an entrance port in the test processor;
said insertion step activating a presence switch which triggers the program to:
capture an image of a portion of the test cassette which includes the test cassette window;
read the captured image; and
process the test results provided as part of the captured image to provide an evaluation thereof and present an output which includes the captured image, the analyzed test results and data entered responsive to the prompts.

16. Portable hand-held apparatus for processing test results obtained by a test strip arranged in a test holder, comprising:
a housing having a port for receiving said holder;
an imaging device in said housing for forming an image of the test results;
a light source adjacent to said imaging device;
a processor in said housing for energizing the light source to illuminate the test strip and activating the imaging device to capture and image of the test results.

17. The apparatus of claim 16, said light source being a pair of LEDs.

18. The apparatus of claim 17, said LEDs emitting green light to enhance the sharpness of the captured image.

19. The apparatus of claim 16, said imaging device having a lens focusing the captured image on the imaging device; and
a filter for reducing glare from the test holder.

20. The apparatus of claim 19, said filter being a Polaroid filter.

21. The apparatus of claim 16, said processor converts the captured image from the imaging device into a digital format suitable for transfer to a portable processor.

22. The apparatus of claim 21, said processor being a personal digital assistant (PDA) arranged in said housing and configured to receive the digital image over a cable.

23. The apparatus of claim 22, said PDA having a type RS232 serial port for receiving the digital image.

24. Portable hand-held apparatus for processing test results obtained by a test strip arranged in a test holder, comprising:
a housing having a port for receiving said holder;
an imaging device in said housing for forming an image of the test results;
a light source for illuminating said port; and
a switch having an operating member normally extending outwardly from said housing for energizing said port to facilitate entry of the test holder under conditions of low ambient light, when the operating member is depressed a given distance.

25. The apparatus of claim 24, said switch energizing said light source only when the operating member is depressed said given distance and configured to return the operating member to the normal position when released.

26. Portable hand-held apparatus for processing test results obtained by a test strip arranged in a test holder, comprising:
a housing having a port for receiving said holder;
an imaging device in said housing for forming an image of the test results;
a processor in said housing for converting the captured image into a format suitable for transfer at an output of said processor;
sensing means for sensing identifying means along a surface of said test holder to identify a type of test holder inserted into said port.

27. The apparatus of claim 26, said sensing means comprising a switch arm which moves when engaging a projection on said test holder to indicate insertion of a test holder.

28. The apparatus of claim 26, said sensing means comprising a plurality of switch arms which move when engaging a projections on said test holder to indicate insertion of a test holder, as well as a type of test holder, the selective presence or absence of projections in a given combination indicating the type of test holder.

29. The apparatus of claim 26, said sensing means comprising a plurality of light sensors for detecting given areas on said test holder which are of given colors to indicate the presence of a test holder, as well as a type of test holder, the colors of said given areas in a given combination indicating the type of test holder.

30. The apparatus of claim 26, said sensing means comprising a plurality of light sensors for detecting given areas on said test holder which are either reflective or non-reflective to indicate insertion of a test holder, as well as a type of test holder, the reflective/non-reflective state of said given areas in a given combination indicating the type of test holder.

31. A method for evaluating test results on a test strip having a plurality of test lines arranged in parallel fashion and a spaced apart from one another by a uniform distance a test line at one end serving as a control line, whereby the a fluid under test enters an end of said test strip remote from the control line, comprising:
a) presenting an image of the test strip on an electronic display:
b) integrating a portion of the displayed image in a given region which includes the control line;
c) integrating a region adjacent to the integrated portion obtained in step (b);
d) comparing the integrated portions obtained in steps (b) and (c); and
e) affirming the presence of the control line when the difference in brightness between the integrated portion is greater than a given threshold.

32. A method for evaluating test results on a test strip having a plurality of test lines arranged in parallel fashion and a spaced apart from one another by a uniform distance a test line at one end serving as a control line, whereby the a fluid under test enters an end of said test strip remote from the control line, comprising:
a) capturing an electronic image of the test strip with a digital imaging device;
b) transferring the electronic image to a processor having an electronic display;
c) presenting the electronic image of the test strip on the display;
d) integrating a portion of the displayed image in a given region which includes the control line;
e) integrating a region adjacent to the integrated portion obtained in step (b);
f) comparing the integrated portions obtained in steps (b) and (c); and
g) affirming the presence of the control line when the difference in brightness between the integrated portion is greater than a given threshold.

33. The apparatus of claim 7, said housing having a guiding opening aligned with a reset button on said PDA to enable a thin instrument to be inserted into said guide opening to reset the PDA without the need for removing the PDA from said housing.
